(19) United States
(12) Patent Application Publication
(10) Pub. No.: US 2015/0170529 A1
(43) Pub. Date: Jun. 18, 2015

(54) System and method for facilitating an online study session

(71) Applicant: Usman Hafeez, Chicago, IL (US)

(72) Inventor: Usman Hafeez, Chicago, IL (US)

(21) Appl. No.: 14/106,435

(22) Filed: Dec. 13, 2013

(51) Int. Cl. G09B 5/00; H04L 29/06

(52) U.S. Cl. CPC G09B 5/00; H04L 65/403

(57) ABSTRACT

The invention is directed toward a system and method for facilitating an online study session. The invention provides for users to view and interact with digital content over a server system. Users may invite additional users to engage in an online study session. The owner of the digital content may give limited control of the digital content to another participant in the online study session. The users may add digital annotations to the digital content during the online study session. Users may search for digital content hosted on the system that is owned by users within the searcher's expanded social network. The system comprises a client computer connected to a server computer with a database through the internet, a social networking software module, a content management software module, a user annotation software module, an interaction platform software module, and communication software modules.

### FIELD OF THE INVENTION

The present invention relates generally to sharing of digital content in a group session and more particularly to a system and method for online group study which permits users to share digital content, communicate with each other in real time, and add and share annotations to the digital content.

### BACKGROUND OF THE INVENTION

Traditionally, students involved in study sessions have relied on viewing books together, especially in regards to one student sharing their highlights, notes and annotations with other students within the group. Frequently, in a study session between students and a tutor or teacher's assistant, there is only one book present, which is used to teach a topic or subject to a student or students. For example, a student who wishes to learn about a certain topic in their math class would go to a math tutor, and bring their book in order to facilitate the studying of material covered in class.

Online teaching systems are known in the art. Historically, online teaching systems provide an online portal for a teacher and pupils to meet together in a virtual setting. These systems have primarily permitted classmates to communicate with each other via chat sessions. In addition, these systems may permit a teacher to display documents and teaching materials to students via the online portal. Teachers may discuss points from the teaching materials and students may ask questions about the teaching materials through the online portal. In the digital age, these teaching materials are likely to be digital files or digital books, commonly known as ebooks.

In addition, the use of these ebooks has grown to a phenomenal level. Digital devices for the display of ebooks are abundant and used throughout society. With the ease of copying and distributing digital files, authors and publishers have become restrictive of the permissions granted to users of electronic files for legal reasons. Technological restrictions known as Digital Rights Management (DRM) were developed and put in place to limit and restrict the illegal dissemination and distribution of electronic files. Most DRM systems prevent copying of electronic files or the viewing of electronic files on unapproved devices.

These current online teaching systems are limited and don't meet the needs of education. The systems are tightly controlled by the teacher in an administrative capacity. These systems do not allow the students to take a lead in presenting information to the group of students or control the use of the system, nor do they allow a student to choose an educator of a particular topic. In addition, these systems do not allow users to add multimedia annotations to the digital content displayed to all students who are engaged in the online classroom. What is needed is a system and method of providing an online study or classroom session which allows multiple users to view and manage the digital content, communicate with each other, and add digital annotations to the digital content used during the education process without compromising the DRM protection of the digital content.

Additionally, the prior art is limited in that any student notes or annotations to digital content is not shareable among students. U.S. Patent Publication US 2012/0179753 describes a system and method of peer-to-peer ebook lending and borrowing. These systems are limited in that the lender gives up master control of the ebook during the loan period and only one user is able to view the same digital content at the same time, thereby hindering group learning. The prior art teaches that a borrower may return a digital ebook prior to the expiration of a predetermined time period but the prior art does not handle a situation where the lender has access to the digital content at the same time that other users can also use the content, but prevents the borrowers from retaining a copy of that digital content. What is needed is a system where the digital content owner retains master control over the digital content during the sharing period and has the ability to allow others within a group of their choosing to view the digital content alongside the digital content owner. In addition, the prior art is limited in that it does not permit users of the systems who are not owners of the digital content to create, edit, or share notes or multimedia annotations concerning any digital ebook. What is needed is a system where a sharer of an ebook may record notes and annotations on the ebook and have those notes and annotations viewable to others.

Students also regularly use study groups as a method to augment or enhance their learning ability. Study sessions allow students to engage in discussion and clarification of teaching materials with other students as well as support one another emotionally and psychologically. One limitation with online teaching systems is that they do not present an efficient means for students to engage together in a study session. What is needed is a system and method which replicates the advantages of in person study sessions by students and tutors.

### SUMMARY OF THE INVENTION

The invention is directed toward a system and method for sharing and viewing digital content to facilitate group studying. The invention is directed toward a method for facilitating an online study group comprising enrolling a first user in a social networking system, hosting digital content owned by the first user on a server computer, permitting the first user to schedule an online study session displaying the digital content owned by the first user, providing a URL to the first user, permitting the first user to invite other users to an online study session hosted on the server computer, displaying the digital content to the participants in an online study session, and ending the online study session when the first user chooses or when the first user logs off of the user account. In this method the first user logs into a user account hosted on the server computer via a client computer. The provided URL redirects a user to the online study session space hosted on the server. The participants view the digital content via client computers connected to the server computer. In this method the first user has control over the digital content during the online study session and all participants in the online study session view the digital content as displayed and manipulated by the first user.

This method may further comprise the first user granting control of the digital content to another participant in the online study session. All participants in the online study session then view the digital content as displayed by the other participant that has control over the digital content. The method may further comprise permitting the first user and the other participants to send and receive voice audio communication and text messages in real time over the server. In addition, the first user may invite other users by sending the URL to the other users by means of text message, email, or social media post. This method may further comprise the other participant requesting control over the digital content from the first user.

Furthermore, this embodiment of the method may further comprise the other participant creating digital annotations to the digital content during the online study session. All participants in the online study session can view the digital annotations on the respective client computers, the other participant's digital annotations are saved as a data file to a database connected to a server computer, and the other participant's digital annotations are directly associated with the other participant's user ID.

Alternatively, in this embodiment, the method may further comprise the first user taking back control of the digital content from the other participant that has control over the digital content at any time during the online study session. Alternatively, in this embodiment, the method may further comprise the other participant that has control over the digital content giving control of the digital content back to the first user.

Furthermore, the users involved in the online study session may be connected to one another through an expanded social media network. Also, this embodiment may further comprise the first user creating digital annotations to the digital content during the online study session, the other participant creating digital annotations to the digital content during the online study session, hosting digital content owned by users of the social networking system on a server computer accessible through a network connection, allowing the first user to search for digital content owned by other users, displaying additional users within the first user's social network that own digital content and can potentially host an online study session displaying the digital content owned by the additional user, transmitting a request to host an online study session from the first user to a second user, wherein the second user appeared in the first user's search results, receiving an acceptance from the second user, permitting the second user to host an online study session displaying the borrowed digital content, and allowing the first user to view multiple levels of social connections and degrees of separation of the first user to other users of the system.

In this embodiment of the method all participants in the online study session can view the first user digital annotations on the respective client computers. The first user digital annotations are saved as a data file to a database connected to a server computer and are directly associated with the first user's user ID. Also, all participants in the online study session can view the other participant's digital annotations on the respective client computers, the other participant's digital annotations are saved as a data file to a database connected to a server computer, and the other participant's digital annotations are directly associated with the other participant's user ID.

In another embodiment of the invention the method comprises enrolling a first user in a social networking system, hosting digital content owned by the first user on a server computer, permitting the first user to schedule an online study session displaying the digital content owned by the first user, providing a URL to the first user, permitting the first user to invite other users to an online study session hosted on the server computer, displaying the digital content to the participants in an online study session, the first user creating digital annotations to the digital content during the online study session, and ending the online study session when the first user chooses or when the first user logs off of the user account. In this method the first user logs into a user account hosted on the server computer via a client computer. The provided URL redirects a user to the online study session space hosted on the server. The participants view the digital content via client computers connected to the server computer. In this method the first user has control over the digital content during the online study session and all participants in the online study session view the digital content as displayed and manipulated by the first user. All participants in the online study session can view the digital annotations on the respective client computers, the first user digital annotations are saved as a data file to a database connected to a server computer, and the first user digital annotations are directly associated with the first user's user ID.

This embodiment of the invention may further comprise the other participant creating digital annotations to the digital content during the online study session. All participants in the online study session can view the digital annotations on the respective client computers, the other participant's digital annotations are saved as a data file to a database connected to a server computer, and the other participant's digital annotations are directly associated with the other participant's user ID.

Alternatively, this embodiment of the invention may further comprise hosting digital content owned by users of the social networking system on a server computer accessible through a network connection, allowing the first user to search for digital content owned by other users, displaying additional users within the first user's social network that own digital content and can potentially host an online study session displaying the digital content owned by the additional user, transmitting a request to host an online study session from the first user to a second user, receiving an acceptance from the second user, permitting the second user to host an online study session displaying the digital content owned by the second user, and allowing the first user to view multiple levels of social connections and degrees of separation of the first user to other users of the system. In this embodiment the second user appeared in the first user's search results.

Furthermore, this embodiment may further comprise allowing the second user of the system to set the level of social connection and degree of separation of the first user permitted to request an online study session hosted by the second user and displaying search results to the first user based on the level of social connection and degree of separation permission set by the second user. In this embodiment the first user is associated with the second user via a chain of person-to-person connections, each person-to-person connection established via the social networking system. This embodiment may further comprise permitting the first user to search for digital content based on digital content name, author, category, subject, class, and school of attendance shared by the first user and the second user and permitting the first user to browse digital content available through the first user's expanded social network. In this embodiment the digital content is an electronic book.

The invention is also directed toward a method for facilitating an online study group comprising enrolling a first user in a social network system, enrolling a second user in a social network system, hosting digital content owned by users of the social networking system on the server computer accessible through a network connection, allowing the first user to search for digital content owned by other users, allowing the first user to view multiple levels of social connections and degrees of separation of the first user to other users of the system, displaying additional users within the first user's social network that own digital content and can potentially host an online study session displaying the digital content owned by the additional user, transmitting a request to host an online study session from the first user to the second user, receiving an acceptance from the second user, permitting the second user to host an online study session displaying the digital content owned by the second user, providing a URL to the first user and the second user, displaying the digital content to the first user and the second user in an online study session wherein the first user and the second user view the digital content via the client computers connected to the server computer, and ending the online study session when the second user chooses or the first user logs off of the user account. In this method the first user logs into a user account hosted on a server computer via a client computer and the second user logs into a user account hosted on the server computer via a client computer. In this method the second user appears in the first user's search results. Also the URL redirects the first user and the second user to the online study session. In addition the second user has control over the digital content during the online study session and the first user views the digital content as displayed and manipulated by the second user.

This embodiment of the invention may further comprise the second user granting control of the digital content to the first user in the online study session, permitting the first user and the second user to send and receive voice audio communication and text messages in real time over the server, allowing the second user taking back control of the digital content from the first user at any time during the online study session, and allowing the first user to give control of the digital content back to the second user at any time during the online study session. In this embodiment the second user views the digital content as displayed and manipulated by the first user.

The invention is also directed toward a system for hosing an online study session. The system comprises a server computer, one or more client computers, a database connected to the server computer, an interface software module, a social networking software module, a content management software module, a voice communication software module, an instant messaging software module, and an interaction platform software module. In this system the client computers are connected to the server computer through a network connection. The digital content files owned by users of the system are stored in the database and are directly associated with the user profile of the user having ownership rights of the digital content file. The interface software module provides an interface between the server and a client computing device and is hosted on the server computer. The social networking software module is hosted on the server computer, connects to a user's existing social network through a third party service, permits a user to create a new social network, and permits the direct association of multiple users and tracks the extended social level connection of multiple users who are not directly associated. The content management software module is hosted on the server computer and directly controls digital files owned by a specific user and the access and viewing of the digital files. The voice communication software module is hosted on the server computer and permits multiple users to send and receive voice audio communication in real time over the server. The instant messaging software module is hosted on the server computer and permits multiple users to send and receive text messages in real time over the server. The interaction platform software module is hosted on the server computer, permits multiple users to interact together in an online study session on the server, permits an owner of digital content to host an online study session with other users, permits the owner of the digital content to change the view of the digital content during the online study session, permits the multiple users to view the changes in view of the digital content, and permits the owner of the digital content to grant an another user present in the online study session to have limited control over the view of the digital content during the online study session.

This system may further comprise a user annotation software module. The user annotation software module permits a user to add annotations and comments to specific digital content. The annotations and comments are stored in a data file associated with the specific digital content and the data file is directly associated with a user profile.

### BRIEF DESCRIPTION OF THE DRAWINGS

FIG. 1 is a schematic view of the system

FIG. 2 is a schematic view of the system

FIG. 3 is a schematic view of a user's search results

FIG. 4 is a schematic view of the process a user undertakes to schedule an online study session

FIG. 5 is a schematic view of the process a user undertakes to start an online study session

FIG. 6 is a schematic view of the process of utilizing digital content during an online study session

FIG. 7 is a schematic view of the process of creating digital annotations during an online study session

FIG. 8 is a schematic view of the process of viewing shared digital annotations

FIG. 9 is a schematic view of the process of searching for other users of the system

### DETAILED DESCRIPTION OF THE DRAWINGS

Although the present invention will be described with reference to the exemplary embodiments shown in the drawings, it should be understood that the present invention can be embodied in many alternate forms or embodiments.

It should be understood that the description of the invention will utilize the term “ebook” for simplicity of the description and notifying the preferred embodiment of the invention. However, the invention is directed toward the sharing of any and all types of digital content. Such digital content includes ebooks, text files, audio files, video files, and any other type of electronic content or data.

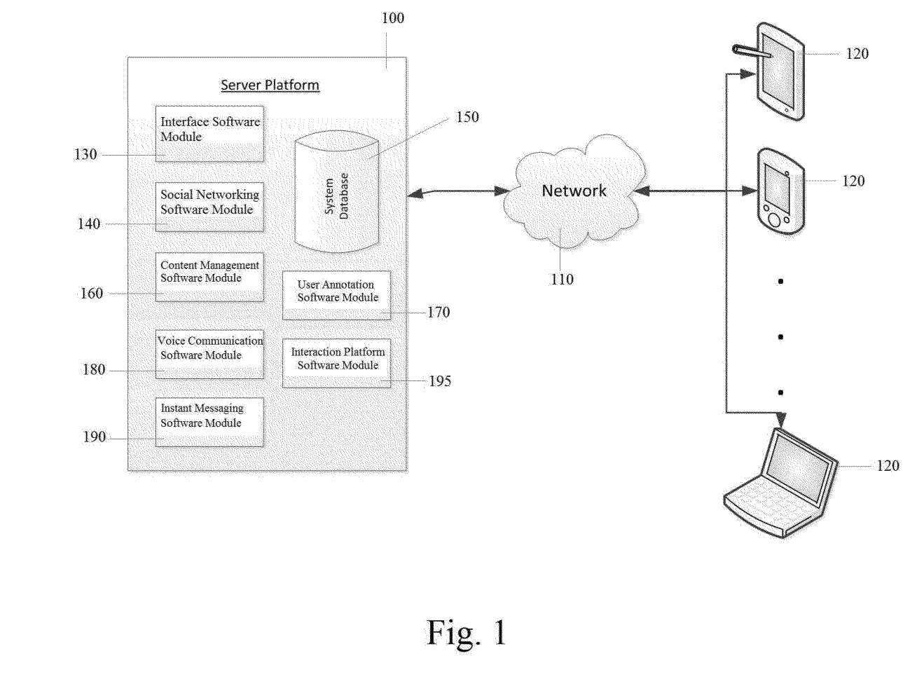

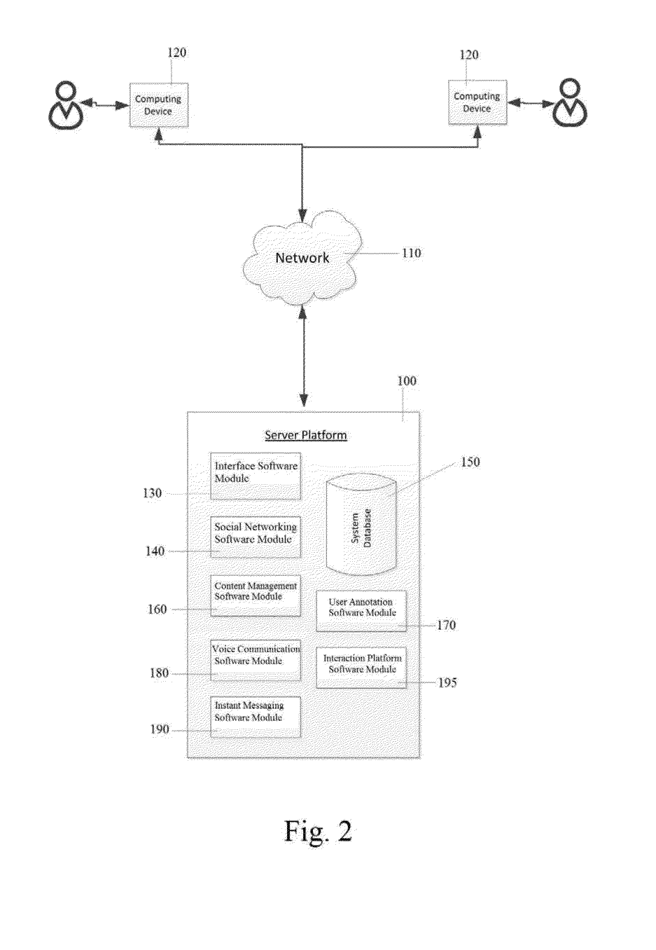

Referring to FIG. 1 and FIG. 2, the system is comprised of a server computer 100 and a client computer 120 connected through a network connection 110. Those having skill in the art would appreciate that the functions performed by the server computer 100 could entail only one server computer 100 or, alternatively, more than one server computer 100 working in tandem. A database 150 is connected to the server computer 100. Hosted on the server computer is an interface software module 130, a social networking software module 140, a content management software module 160, a user annotation software module 170, a voice communication software module 180, an instant messaging software module 190, and an interaction software module 195. As shown in FIG. 1, the system may be used by an individual on any type of client computer 120, including a tablet computer, a web enabled cellular phone, or a laptop. As shown in FIG. 2, a first user may use the system on the first user's client computer 120 to connect with and transfer digital content to a second user on the second user's client computer 120. In this embodiment one user may connect with another user directly from one client computer 120 to another client computer 120, without the need to communicate through the server computer. This may occur by means of Bluetooth or Near Field Communication (NFC) or other wireless communication technology that allows one client computer 120 to communicate with another client computer 120. Additionally, one client computer 120 may communicate directly with another client computer 120 through a wired connection. This embodiment is most prevalent when one user utilizes a mobile application to engage with another user who also has a mobile application when a digital content file is stored on a mobile cellular device. The interface software module 130 allows a user to create a unique password protected user ID. Information about the user, including contact information, is stored on the server computer 100 in connection with the user's user ID. The user may then purchase the master rights to any digital ebook. The master digital file of the digital ebook is stored on the server computer 100 in the system database 150. Alternatively, the user may upload digital files to the system for storage of ebooks for which the user has already purchased full rights. In this way, the user creates a personal digital library which is stored on the system database 150. When a user desires to read an ebook that is stored on the system database 150, the user accesses the digital file from a client computer 120 or device. The client computer 120 can be any web enabled computing device such as a laptop computer, desktop computer, e-reader, tablet computer, PDA, smart phone or other computing device that allows for the display of eBooks. The user may read the ebook through a web browser without downloading the digital file to the client computer. Alternatively, the user may download a copy of the digital file to the client computer 120 and read the ebook through a viewer program.

The system also entails a user annotation software module 170 which allows the user to add annotations or comments to the digital ebook. This process is desirable when a user is reading an ebook for educational purposes or if the user is reading the ebook as part of a book club. The user may highlight text in the ebook. The user may add comments, notes, or multimedia annotations to particular parts of the text in the margins of the ebook. Multimedia annotations can take the form of images, videos, audio, 3D files (for use with a 3D printer), attached documents, and other files. The annotations are saved on the server computer 100 in connection with the ebook and the user ID. When the user later accesses the ebook, any saved annotations and comments are displayed with the ebook for the user to review.

The system also entails a software networking software module 140 allowing users of the system to become linked together into a social network where the users are displayed in degrees of separation, or to connect using an existing social network, such as Facebook, LinkedIn, Twitter, Google Plus, etc.

The system also contains a voice communication software module 180 and an instant messaging software module 190. The voice communication software module 180 permits the users to speak to one another over the server computer 100 in VOIP. Each user would speak into a microphone connected to the user's respective client computer 120. The audio input is transmitted over the server computer 100 to the respective client computers 120. Each user engaged together in the online study session would hear the ongoing audio through the audio speakers of their respective client computer 120. The instant messaging software module 190 permits the users to type messages to one another in real time. A user would type in a message to the other users engaged in the online study session in that user's client computer 120. The typed message is transmitted to the server computer 100 and is posted in the online study session for all users to read.

The system also contains an interaction platform software module 195. The interaction platform software module 195 provides for an online chatroom type setting for all users to engage in together during an online study session. The interaction software module 195 contains user graphical interface segments and provides an overarching structure for the other software modules to interact and coordinate together during an online study session.

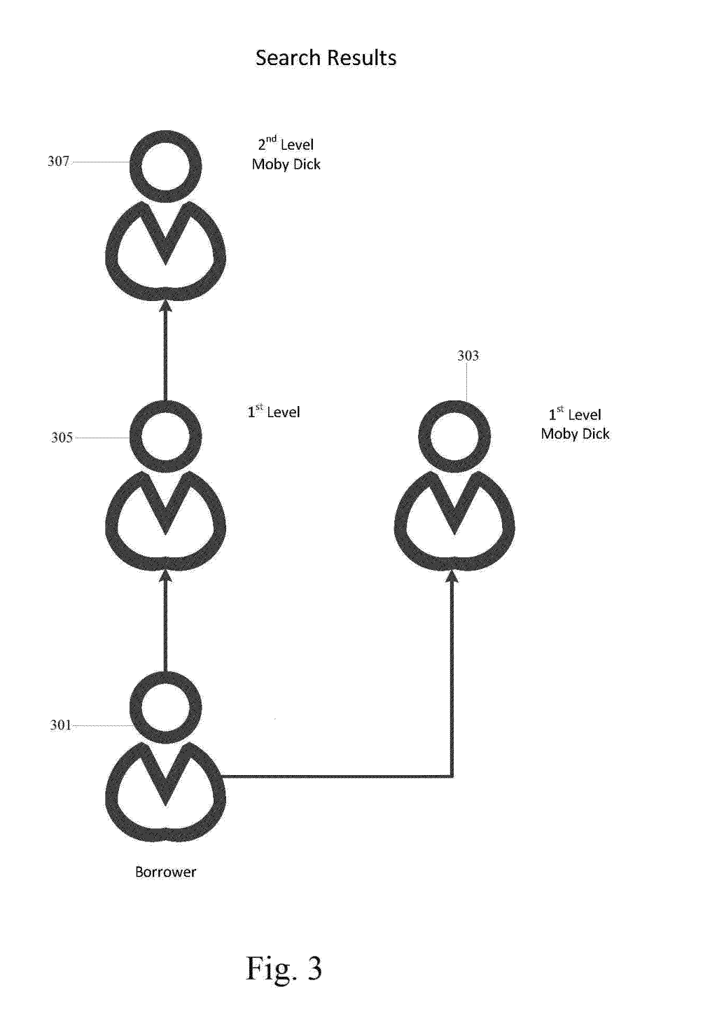

The invention permits a user to search for digital content owned by other users and request the digital content owner to host an online study session. FIG. 3 demonstrates a sample of search results that a first user 301 may view when searching for a specific digital content file through the first user's 301 social network. The first user may search for those users within the first user's 301 expanded social network who own the title Moby Dick. The first user 301 may find a second user 303 who is a first level connection of the first user 301. The first user 301 can see that the second user 303 owns the title Moby Dick and that the second user 303 has indicated that the title is available for an online study session. The first user 301 may then send a request for an online study session to the second user 303. If the second user 303 has indicated that the title is not available for other users, the first user 301 may look for other users within the first user's 301 expanded social network who own the title Moby Dick and have indicated that the title is available for others to view in an online study session. The first user may find that a fourth user 307 owns the title Moby Dick and has indicated that the titled is available for others to view in an online study session. The fourth user 307 is a second level social connection with the first user 301. The fourth user 307 is not a direct connection to the first user 301, but is instead a “friend of a friend.” The first user 301 is a first level connection with a third user 305, who is in turn a first level connection with the fourth user 307. This makes the fourth user 307 a second level connection with the first user 301. In this manner, the users of the system are grouped together into an expandable social network system. The system tracks the degree of connection between users such that a “friend” is a first degree connection, a “friend” of a “friend” is a second degree connection, a “friend” of a “friend” of a “friend” is a third degree connection, and so forth until all connected users are incorporated into the proper degrees of connection to a first user 301.

The content management software module 160 allows a user to host an online study session displaying digital content, such as ebooks, from the user's personal library to other users. The user may host an online study session displaying digital ebooks from the user's personal library to other users of the system provided that the user has approved of such hosting. The user may decide to host an online study session displaying an ebook but authorize other user who may participate in the online study session based upon the degree of connection of other users. For instance, if the user authorizes the display of the ebook to first degree connections the first degree connections may participate in the online study session but second degree connections may not participate in the online study session. However, if the user authorizes the display of the ebook to second degree connections then both first degree connections and second degree connections may participate in the online study session but third degree connections may not. The user may also host an online study session and invite other users to attend without restriction based on level of social connection.

The content management software module 160 is established such that a user may search the personal libraries of other users based upon title of the ebook, author of the ebook, name of the social connection, degree of connection, and any other parameter established by a system administrator. For example, and by no means a limitation of the system, a first user 301 may decide that he desires an online study session concerning Moby Dick. The first user 301 may search for the title Moby Dick. The results may display that a second user 303, who is a first degree connection, possesses Moby Dick in her personal library. The first user 301 may submit a request for an online study session to the second user 303 to view the Moby Dick ebook. The second user 303 may approve or decline the request. If the second user 303 has approved the request then the second user 303 will be able to schedule an online study session with the first user 301 to display and discuss the Moby Dick ebook.

If the first user 301 performs a search for Moby Dick and sees that a fourth user 307, who is a second degree connection through a third user 305, has Moby Dick in her personal library, the first user 301 may see whether he is within the proper degree of connections for which the second degree connection has granted authorization to display the ebook in an online study session. If the second degree connection has only authorized the display of Moby Dick in an online study session to first degree connections then the first user 301 will be unable to view the ebook in an online study session unless and until the second degree connection has authorized the display of the ebook in an online study session to second degree connections. The first user 301 may still send a request to the second degree connection even though the first user knows that the second degree connection has not authorized the display of the ebook in an online study session to second degree connections. The second degree connection may choose to ignore the request, connect directly with the second degree connection and thus change the connection to a first degree connection, or change the display parameters of the ebook to allow second degree connections to view the ebook in an online study session. In another embodiment of the invention, the second degree connection may choose to simply deny all requests from those users outside of the authorized degree of connection. In this embodiment, the first user will be unable to send a request to the second level connection. However, if the second degree connection has authorized the display of Moby Dick in an online study session to second degree connections then the process is the same as noted above.

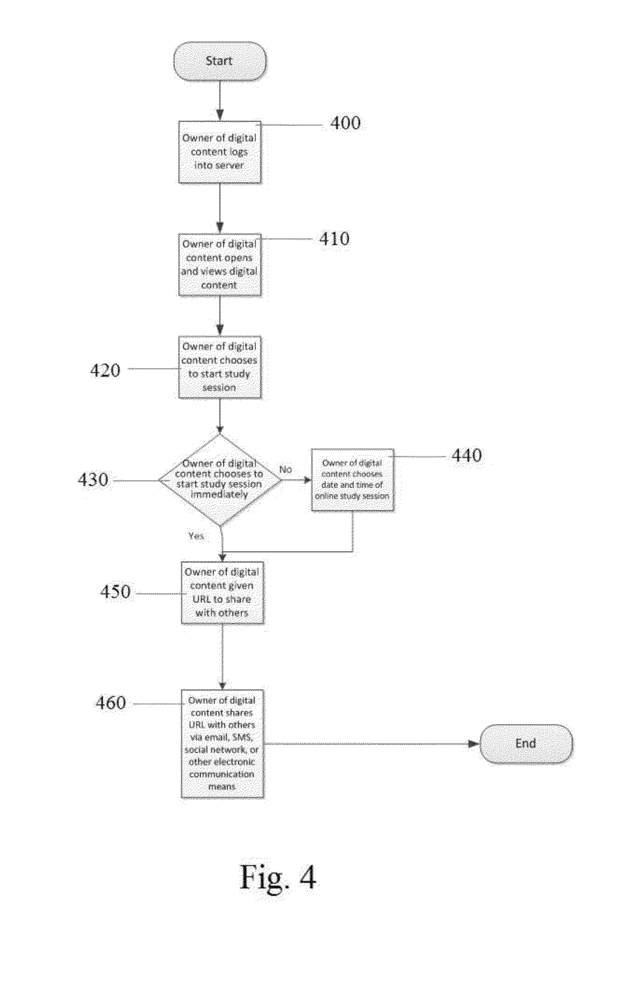

Referring to FIG. 4, the process of scheduling an online study session is displayed. First, the owner of the digital content logs into the server computer 400. Next, the owner of the digital content opens and views the digital content about which the owner desires to schedule an online study session 410. The owner of the digital content may choose to start an online study session 420. The owner of the digital content may choose to start the online study session immediately 430. If the owner chooses to not start the online study session immediately then the owner of the digital content may choose the date and time to schedule the online study session 440. Regardless of when the owner of the digital content desires to schedule an online study session, the owner of the digital content is given a URL to the online study session platform to share with other users 450. The owner of the digital content then shares the URL with other uses via email, social network, SMS, or any other electronic communication means 460.

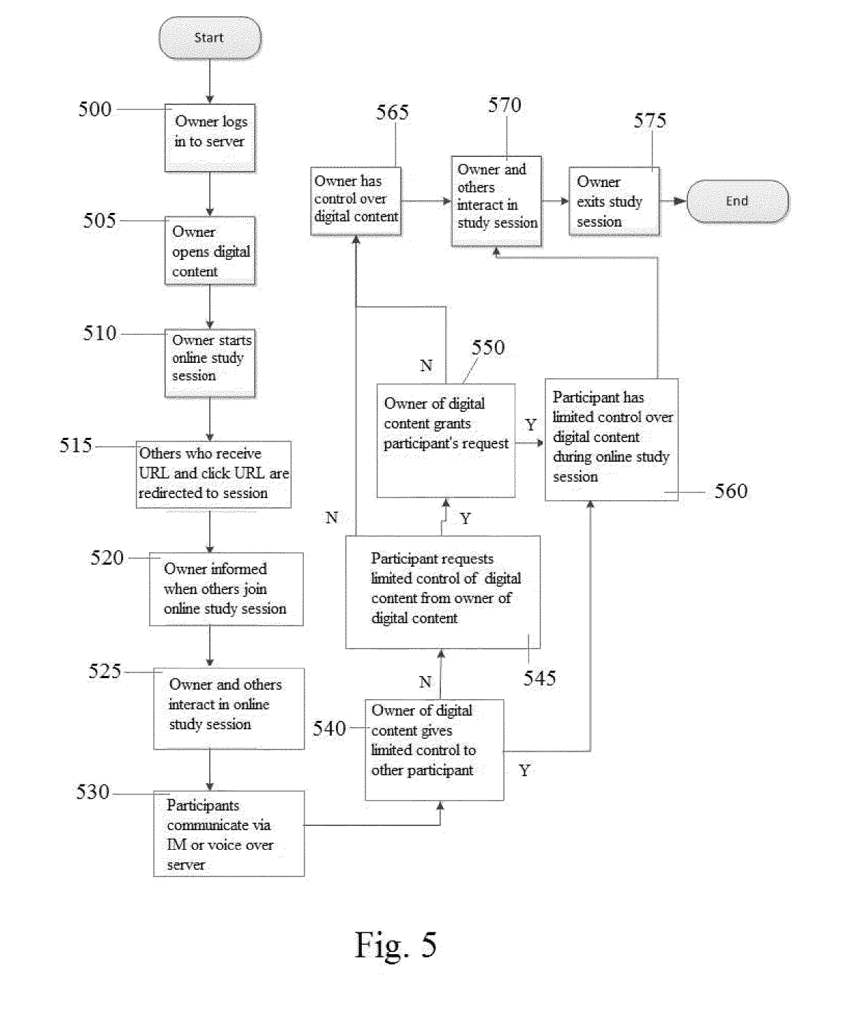

Referring to FIG. 5, the process utilized during an online study session is displayed. First the owner of the digital content logs into the server 500. Then the owner of the digital content opens and views the desired digital content 505. The owner of the digital content then starts the online study session 510. Next, the other users who received the URL click on the URL and are redirected to the online study session platform 515. The owner of the digital content is informed when the other users join the online study session 520. The owner of the digital content and the others then interact in the online study session 525. The participants in the online study session communicate with each other by instant message and voice communication over the server 530. During this time the owner of the digital content has control over the digital content. In the online study session all of the participants view the same information and content. The participants can view the names of the other users in the online study session, the instant message history, the digital content, and the annotations to the digital content. The owner of the digital content has control over the digital content and what portions of the digital content and annotations to the digital content that all of the participants view during the online study session. The owner of the digital content can change which page of the digital content is being viewed by all of the participants. The owner of the digital content can also highlight or annotate portions of the digital content. Any changes being made to digital content at this time are viewed by all participants. All participants in the online study session view the same information on their respective client computers 120.

In addition, other participants in the online study session may take control of the digital content during the online study session. The owner of the digital content may give limited control of the digital content to another participant 540. If the owner of the digital content gives limited control to another participant then the participant has limited control over the digital content during the online study session 560. If the owner of the digital content does not give limited control of the digital content to another participant, then the participant may request to have limited control of the digital content from the owner of the digital content 545. When a participant requests to have limited control, the owner of the digital content may grant the participant's request 550. If the owner does not grant the participant's request, then the owner of the digital content continues to have control over the digital content during the online study session 565. If the owner grants the participant's request, then the participant has limited control over the digital content during the online study session 560. At any time, the owner of the digital content may take back control of the digital content from the participant. If the owner of the digital content does take back control then the owner of the digital content has control over the digital content during the online study session 565. Alternatively, the participant may give control of the digital content back to the owner of the digital content. When the participant has limited control over the digital content then the participant controls which sections of the digital content and annotations to the digital content are being viewed by all participants during the online study session.

When the participant has limited control over the digital content, the owner of the digital content and the others continue to interact in the online study session 570. Also, when the owner of the digital content either had not given control of the digital content or gets back control of the digital content, the owner of the digital content and the others can continue to interact in the online study session 570. When the online study session is over and the owner of the digital content exits the study session 575, the owner of the digital content maintains ultimate control and access to the digital content. When the owner of the digital content ends the online study session 575, the study session ends for all participants simultaneously. No participant can continue in the online study session without the owner of the digital content being present in the online study session.

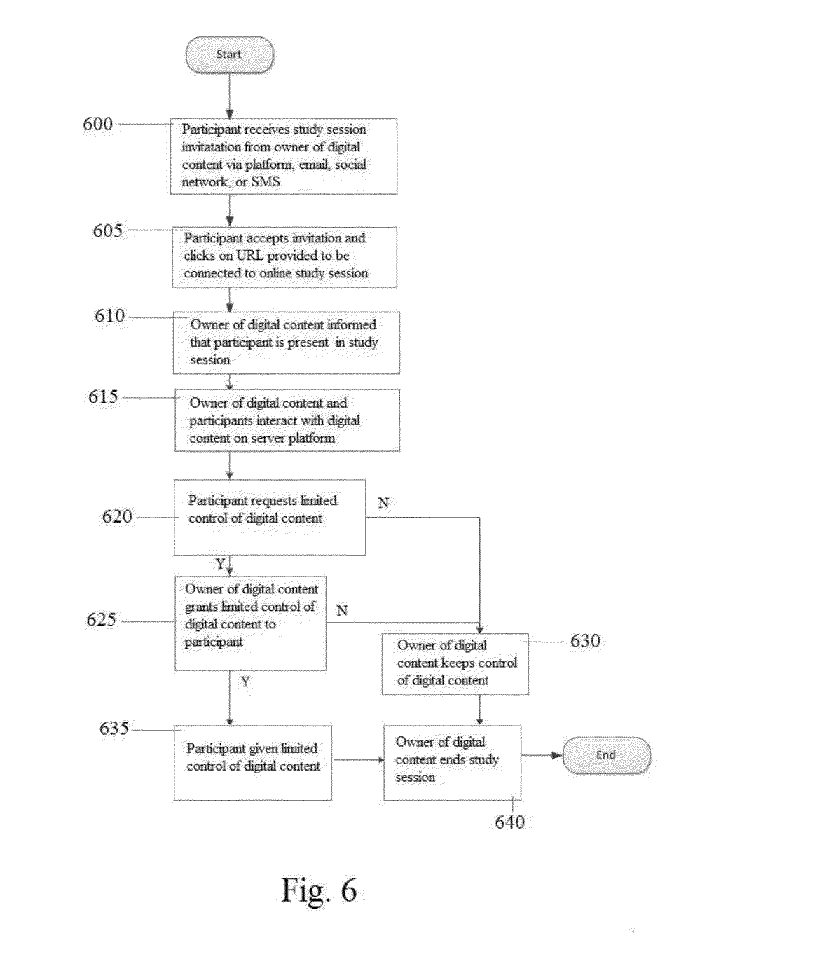

Referring to FIG. 6, the process of engaging in the online study session is displayed from the participant's point of view. The process starts when the participant receives a study session invitation from the owner of the digital content via the platform, email, social network, SMS, or any other means of electronic communication 600. The participant accepts the invitation and clicks on the URL provided and is redirected to the online study session 605. The owner of the digital content is informed that the participant has entered the online study session 610. The owner of the digital content and the participant interact with the digital content on the server platform 615. The participant may request to have limited control of the digital content 620. If the participant does not request limited control over the digital content then the owner of the digital content keeps control of the digital content 630. If the participant requests limited control of the digital content, the owner of the digital content may grant limited control of the digital content to the participant 625. If the owner of the digital content does not grant limited control of the digital content to the participant then the owner of the digital content keeps control of the digital content 630. If the owner of the digital content grants limited control of the digital content to the participant then the participant is given limited control of the digital content 635. When the session is over, the owner of the digital content ends the study session 640.

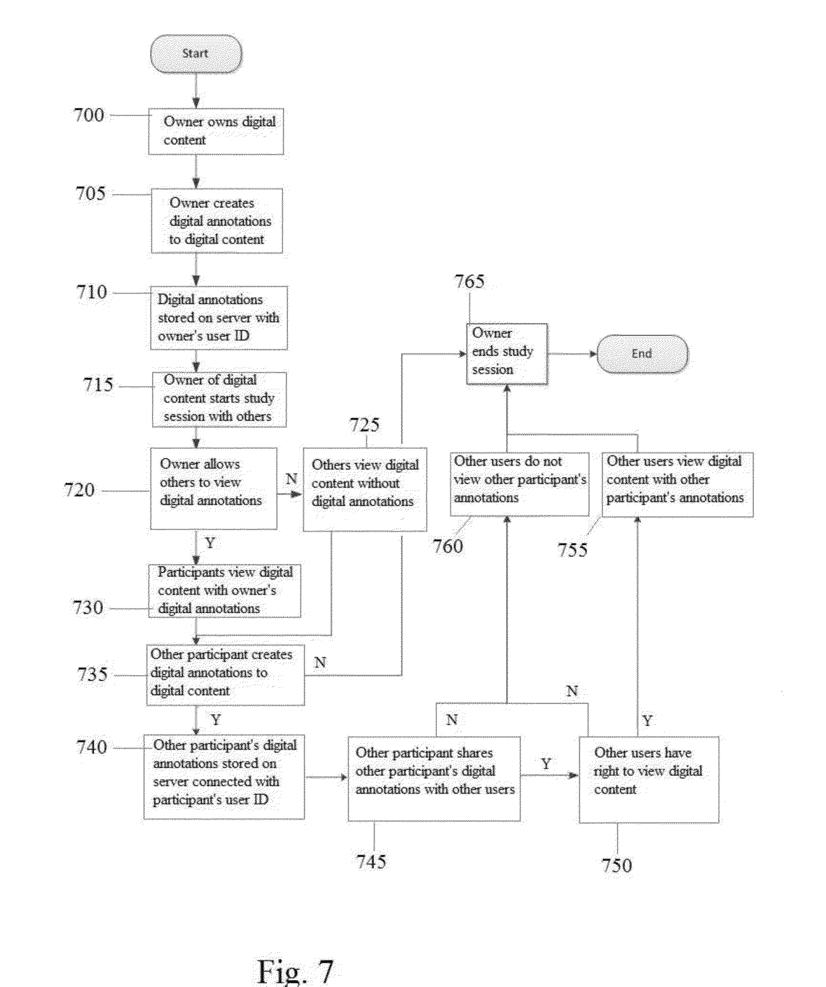

The owner of the digital content has the ability to create digital annotations to the digital content and share those digital annotations with others within the online study session. Likewise, participants in the online study session may create and share digital annotations to the digital content during the online study session. FIG. 7 displays the process by which users create digital annotations to the digital content. First, the owner owns the digital content 700. At any time, the owner creates digital annotations to the digital content 705. The owner of the digital content may create digital annotations to the digital content prior to starting the online study session or during the online study session. The owner's digital annotations are stored on the server in connection with the owner's user ID 710. The owner of the digital content starts the online study session and the owner of the digital content and the other participants interact in the online study session 715. The owner of the digital content may decide whether to give permission to the participants in the online study session to view the owner's digital annotations to the digital content 720. If the owner of the digital content grants the other participants the right to view the owner's digital annotations then the other participants view the digital content with the owner's digital annotations 730. If the owner of the digital content does not grant the other participants the right to view the owner's digital annotations then the other participants view the digital content without the owner's digital annotations 725. At any time during the online study session, any of the other participants may create digital annotations to the digital content 735. The other participant's digital annotations are stored on the server in connection with the participant's user ID 740. The participant may decide whether or not to share the participant's digital annotations with other users outside of the online study session 745. If the participant does share the participant's digital annotations with other users then the system determines whether the other user has the right to view the digital content 750. The other participant would have the right to view the digital content if the other user has separate ownership rights to the digital content. If the other user does not have the right to view the digital content then the other user does not view the other participant's digital annotations 760. If the other user does have the right to view the digital content then the other user views the digital content with the other participant's digital annotations 755. If the other participant does not share the participant's digital annotations with other users then the other users do not view the participant's digital annotations 760. When the online study session is over the owner of the digital content ends the online study session 765. When the online study session is over the participant cannot create digital annotations to the digital content unless the participant also has ownership rights to the digital content. In addition, the participant cannot view the participant's digital annotations outside of the online study session unless the participant has ownership rights to the digital content. In that way, the system is designed to promote the sale of digital content files to additional users.

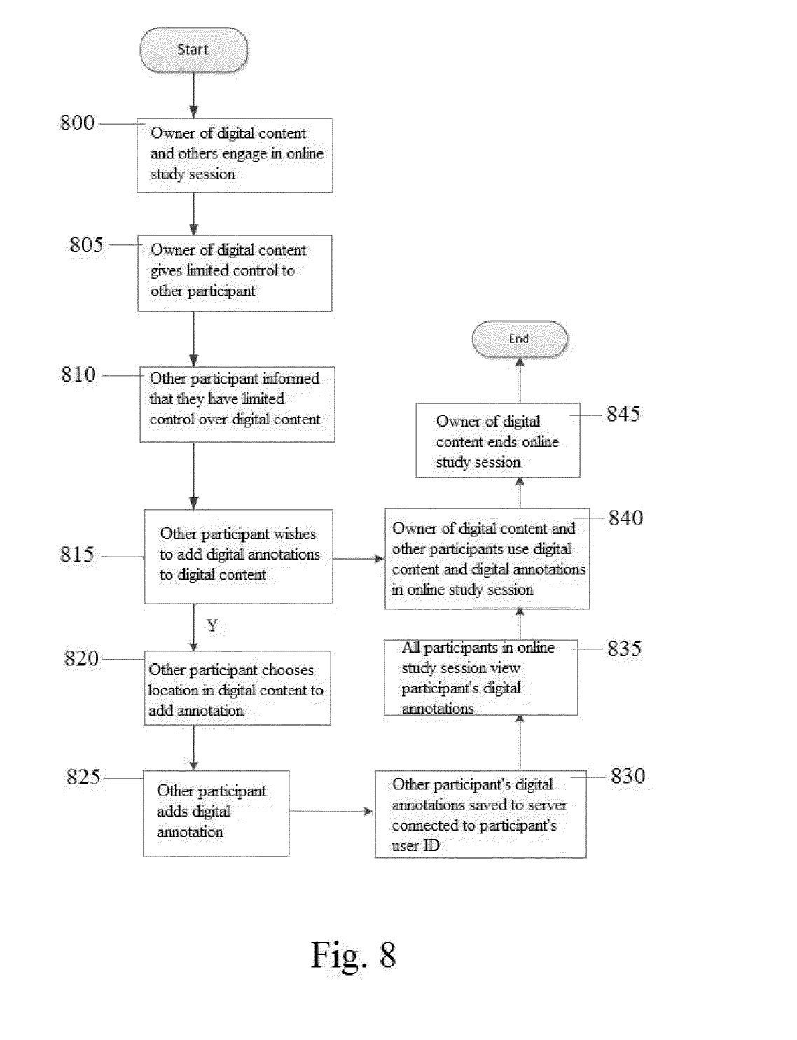

Participants in the online study session may create digital annotations to the digital content during the online study session when the participant has control over the digital content. FIG. 8 displays the process that a participant utilizes to create digital annotations during the online study session when the participant has control over the digital content. In this process the owner of the digital content and other participants are engaged in the online study session 800. The owner of the digital then gives limited control over the digital content to another participant 805. The other participant is informed that the other participant now has limited control over the digital content 810. The other participant may then decide whether or not the other participant adds digital annotations to the digital content 815. If the other participant does not add any digital annotations then the owner of the digital content and the other participants use the digital content and existing digital annotations in the online study session 840. The online study session then ends when the owner of the digital content ends the online study session 845. If the other participant does decide to add digital annotations then the other participant chooses the location in the digital content to add the digital annotation 820. The other participant then adds the digital annotation 825. The other participant's digital annotations are saved to the server in connection with the other participant's user ID 830. Because the other participant has limited control over the digital content and is leading the online study session, al participants in the online study session view the other participant's digital annotations during the online study session 835. The owner of the digital content and the other participants then use the digital content and digital annotations in the online study session 840. The online study session then ends when the owner of the digital content ends the online study session 845.

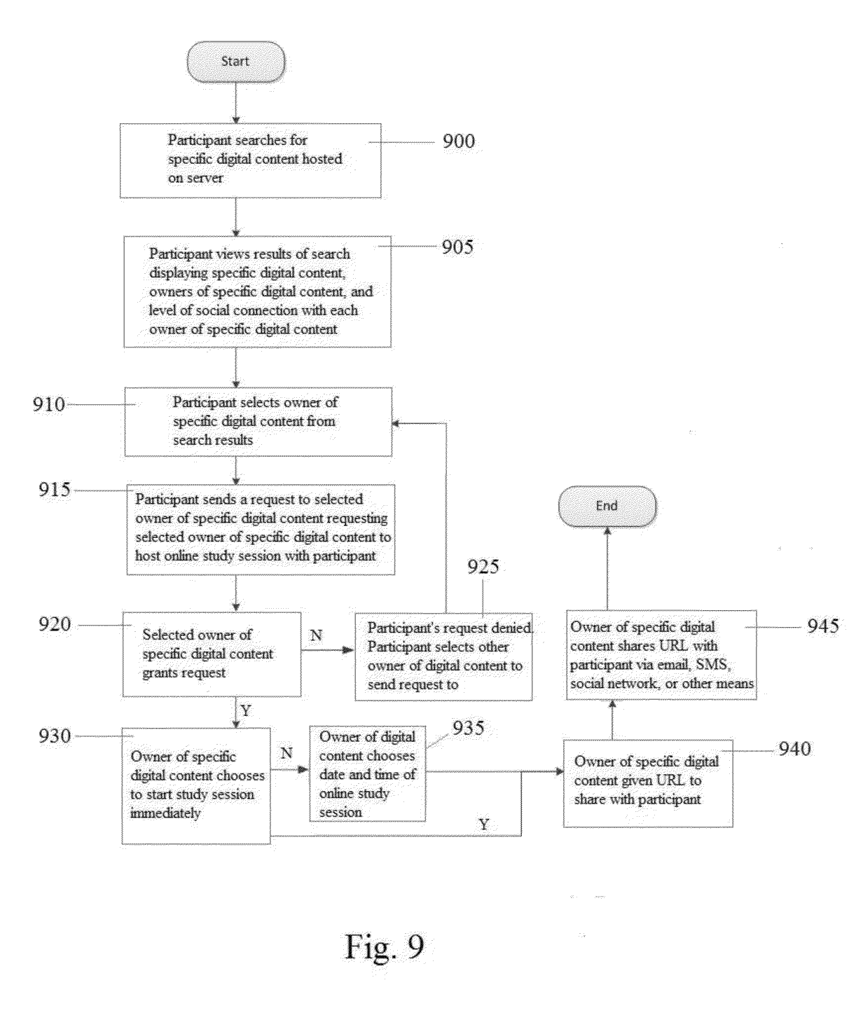

Any user of the system may request to engage in a study session with another user of the system. For instance, a student may seek a tutor to discuss a specific digital content file. In addition, a user who does not own a specific digital content file may seek to engage in an online study session with a user who does own a specific digital content file. Referring to FIG. 9, the process a user engages in to search for another user for an online study session is displayed. The process starts when the participant searches for specific digital content that is hosted on the server 900. The participant then views the results of the search, the search results displaying the specific digital content files, the owners of those specific digital content files, and the level of social connection that the participant has with each owner of the specific digital content files displayed in the search results 905. The participant then selects an owner of a digital content file from the search results 910. The participant then sends a request to the selected owner of the specific digital content file requesting that the selected owner host an online study session with the participant 915. The selected owner may then grant the participant's request 920. If the selected owner denies the request then the participant's request is denied and the participant may select another owner of the specific digital content file to send a separate request to 925. If the selected owner grants the request then the owner of the specific digital content chooses whether or not to start the online study session immediately 930. If selected owner chooses to start the online study session immediately then the owner of the specific digital content is given a URL to share with the participant 940. The owner of the specific digital content then shares the URL with the participant via email, SMS, social network, the platform, or any other means of electronic communication 945. If the owner of the digital content decides not to start the online study session immediately then the owner of the digital content chooses a date and time to start the online study session 935. After scheduling the online study session the owner of the specific digital content is given a URL to share with the participant 940. The owner of the specific digital content then shares the URL with the participant via email, SMS, social network, the platform, or any other means of electronic communication 945.

1. A method for facilitating an online study group comprising
Enrolling a first user in a social networking system
Hosting digital content owned by said first user on a server computer Said first user logging into a user account hosted on said server computer via a client computer
Permitting said first user to schedule an online study session displaying said digital content owned by said first user
Providing a URL to said first user
Said URL redirecting a user to an online study session space hosted on said server
Permitting said first user to invite other users to an online study session hosted on said server computer
Displaying said digital content to the participants in an online study session
wherein said participants view said digital content via client computers connected to said server computer
Wherein said first user has control over said digital content during said online study session
Wherein all participants in said online study session view said digital content as displayed and manipulated by said first user
Ending said online study session when said first user chooses or when said first user logs off of said user account.

2. The method as in claim 1 further comprising
Said first user granting control of said digital content to another participant in the online study session
Wherein all participants in said online study session view said digital content as displayed by said other participant having control over said digital content.

3. The method as in claim 2 further comprising
Permitting said first user and said other participants to send and receive voice audio communication in real time over said server
Permitting said first user and said other participants to send and receive text messages in real time over said server.

4. The method as in claim 3
Wherein said first user invites other users by sending said URL to said other users by means of text message, email, or social media post.

5. The method as in claim 4 further comprising
Said other participant requesting control over said digital content from said first user.

6. The method as in claim 5 further comprising
Said first user taking back control of said digital content from said other participant having control over said digital content at any time during the online study session.

7. The method as in claim 5 further comprising
Said other participant having control over said digital content giving control of said digital content back to said first user.

8. The method as in claim 5 further comprising
Permitting a user participating in the online study session to display a second digital content file owned by said user to all participants within the online study session.

9. The method as in claim 8
Wherein the users involved in the online study session are connected to one another through an expanded social media network.

10. The method as in claim 9 further comprising
Said first user creating digital annotations to said digital content during said online study session
Wherein all participants in the online study session can view said first user digital annotations on said respective client computers
Wherein said first user digital annotations are saved as a data file to a database connected to a server computer
Wherein said first user digital annotations are directly associated with said first user's user ID
Said other participant creating digital annotations to said digital content during said online study session
Wherein all participants in the online study session can view said other participant's digital annotations on said respective client computers
Wherein said other participant's digital annotations are saved as a data file to a database connected to a server computer
Wherein said other participant's digital annotations are directly associated with said other participant's user ID
Hosting digital content owned by users of said social networking system on a server computer accessible through a network connection
Allowing said first user to search for digital content owned by other users
Displaying additional users within said first user's social network that own digital content and can potentially host an online study session displaying said digital content owned by said additional user
Transmitting a request to host an online study session from said first user to a second user, wherein said second user appeared in said first user's search results
Receiving an acceptance from said second user
Permitting said second user to host an online study session displaying said borrowed digital content
Allowing said first user to view multiple levels of social connections and degrees of separation of said first user to other users of the system.

11. The method as in claim 1 further comprising
Said first user creating digital annotations to said digital content during said online study session
Wherein all participants in the online study session can view said digital annotations on said respective client computers
Wherein said first user digital annotations are saved as a data file to a database connected to a server computer
Wherein said first user digital annotations are directly associated with said first user's user ID.

12. The method as in claim 11 further comprising
Said other participant creating digital annotations to said digital content during said online study session
Wherein all participants in the online study session can view said digital annotations on said respective client computers
Wherein said other participant's digital annotations are saved as a data file to a database connected to a server computer
Wherein said other participant's digital annotations are directly associated with said other participant's user ID.

13. The method as in claim 2 further comprising
Said other participant creating digital annotations to said digital content during said online study session
Wherein all participants in the online study session can view said digital annotations on said respective client computers
Wherein said other participant's digital annotations are saved as a data file to a database connected to a server computer
Wherein said other participant's digital annotations are directly associated with said other participant's user ID.

14. The method as in claim 11 further comprising
Hosting digital content owned by users of said social networking system on a server computer accessible through a network connection
Allowing said first user to search for digital content owned by other users
Displaying additional users within said first user's social network that own digital content and can potentially host an online study session displaying said digital content owned by said additional user
Transmitting a request to host an online study session from said first user to a second user, wherein said second user appeared in said first user's search results
Receiving an acceptance from said second user
Permitting said second user to host an online study session displaying said digital content owned by said second user
Allowing said first user to view multiple levels of social connections and degrees of separation of said first user to other users of the system.

15. The method as in claim 14 further comprising:
Wherein said first user is associated with said second user via a chain of person-to-person connections, each person-to-person connection established via the social networking system.
Allowing said second user of the system to set the level of social connection and degree of separation of said first user permitted to request an online study session hosted by said second user
Displaying search results to said first user based on the level of social connection and degree of separation permission set by said second user.

16. The method as in claim 15 further comprising
Permitting said first user to search for digital content based on digital content name, author, category, subject, class, and school of attendance shared by said first user and said second user
Permitting said first user to browse digital content available through said first user's expanded social network
wherein the digital content is an electronic book.

17. A method for facilitating an online study group comprising
Enrolling a first user in a social network system
Said first user logging into a user account hosted on a server computer via a client computer
Enrolling a second user in a social network system
Said second user logging into a user account hosted on said server computer via a client computer
Hosting digital content owned by users of said social networking system on said server computer accessible through a network connection
Allowing said first user to search for digital content owned by other users.
Allowing said first user to view multiple levels of social connections and degrees of separation of said first user to other users of the system
Displaying additional users within said first user's social network that own digital content and can potentially host an online study session displaying said digital content owned by said additional user
Transmitting a request to host an online study session from said first user to said second user, wherein said second user appeared in said first user's search results
Receiving an acceptance from said second user
Permitting said second user to host an online study session displaying said digital content owned by said second user
Providing a URL to said first user and said second user, said URL redirecting said first user and said second user to said online study session
Displaying said digital content to said first user and said second user in an online study session wherein said first user and said second user view said digital content via said client computers connected to said server computer
Wherein said second user has control over said digital content during said online study session
Wherein said first user views said digital content as displayed and manipulated by said second user
Ending said online study session when said second user chooses or said first user logs off of said user account.

18. The method as in claim 17 further comprising
Said second user granting control of said digital content to said first user in the online study session
Wherein said second user views said digital content as displayed and manipulated by said first user
Permitting said first user and said second user to send and receive voice audio communication in real time over said server
Permitting said first user and said second user to send and receive text messages in real time over said server
Allowing said second user taking back control of said digital content from said first user at any time during the online study session
Allowing said first user to give control of said digital content back to said second user at any time during the online study session.

19. A system for hosting an online study session comprising:
A server computer
One or more client computers
Wherein said client computers are connected to said server computer through a network connection
A database connected to said server computer
Wherein digital content files owned by users of the system are stored in said database
Wherein said digital content files are directly associated with the user profile of the user having ownership rights of the digital content file
An interface software module
Wherein said interface software module provides an interface between said server and a client computing device
Wherein said interface software module is hosted on said server computer
A social networking software module
Wherein said social networking software module is hosted on said server computer
Wherein said social networking module connects to a user's existing social network through a third party service
Wherein said social networking module permits a user to create a new social network
Wherein said social networking software module permits the direct association of multiple users and tracks the extended social level connection of multiple users who are not directly associated
A content management software module
Wherein said content management software module is hosted on said server computer
Wherein said content management application directly controls digital files owned by a specific user and the access and viewing of said digital files
A voice communication software module
Wherein said voice communication software module is hosted on said server computer
Wherein said communication software module permits multiple users to send and receive voice audio communication in real time over said server
An instant messaging software module
Wherein said instant messaging software module is hosted on said server computer
Wherein said instant messaging software module permits multiple users to send and receive text messages in real time over said server
An interaction platform software module
Wherein said interaction platform software module is hosted on said server computer
Wherein said interaction platform software module permits multiple users to interact together in an online study session on said server
Wherein said interaction platform software module permits an owner of digital content to host an online study session with other users
Wherein said interaction platform software module permits said owner of said digital content to change the view of said digital content during said online study session
Wherein said interaction platform software module permits said multiple users to view said changes in view of said digital content
Wherein said interaction platform software module permits the owner of said digital content to grant an another user present in the online study session to have limited control over the view of said digital content during said online study session.

20. The system as in claim 19 further comprising
A user annotation software module
Wherein said user annotation software module permits a user to add annotations and comments to specific digital content
Wherein said annotations and comments are stored in a data file associated with said specific digital content
Wherein said data file is directly associated with a user profile.
